(19) United States
(12) Patent Application Publication
(10) Pub. No.: US 2014/0145820 A1
(43) Pub. Date: May 29, 2014

(54) METHOD FOR GENERATING A CURRENTLY VALID ONE-TIME RELEASE CODE FOR AN ELECTRONIC LOCK

(71) Applicants: Benjamin Schwarze, Koeln (DE); Peter Bock, Schwelm (DE); Matthias Blunck, Mettmann (DE)

(72) Inventors: Benjamin Schwarze, Koeln (DE); Peter Bock, Schwelm (DE); Matthias Blunck, Mettmann (DE)

(73) Assignee: BELOXX NEWTEC GMBH, Wuppertal (DE)

(21) Appl. No.: 14/119,540

(22) PCT Filed: May 23, 2012
(86) PCT No.: PCT/EP2012/002176

§ 371 Date: Jan. 21, 2014

(30) Foreign Application Priority Data
May 25, 2011 (DE) 10 2011 103 134.4

(51) Int. Cl. G07C 9/00

(52) U.S. Cl. CPC G07C 9/00817
USPC 340/5.26

(57) ABSTRACT

The invention relates to a method for generating a currently valid one-time release code (1) for an electronic lock (9), which can be transitioned from the locked state thereof to the released state thereof by entering the currently valid one-time release code (1). In order to provide an electronic lock (9) having very high security against unauthorized actuation, according to the invention the currently valid one-time release code (1) is generated by encrypting the immediately previously valid one-time release code (5) by means of an encrypting algorithm (6), wherein the encryption takes place in consideration of an encrypting code (4) generated from an individual master code (2) that is entered and a key code (3) that is stored in the electronics of the lock (9).

The invention relates to a method for generating a currently valid one-time release code for an electronic lock, which can be transitioned from its locked state to its released state by means of entering this currently valid one-time release code.

Furthermore, the invention relates to an electronic lock that can be transitioned from its locked state to its released state by means of entering a currently valid one-time release code.

Furthermore, the invention relates to a system having an electronic lock and an electronic device disposed separate from the lock.

Electronic locks are provided, for example, for locking the closed position of closure elements on cabinets, safe deposit boxes, post office boxes, or rooms. By means of entering a release code into the electronic lock, the latter can be transitioned from its locking state, in which the closed position is locked, to its released state, in that the closure element can be moved into one of its open positions, by means of manual actuation. Such a release code can be formed by a sequence of numbers, for example.

In order to increase the security of such electronic locks and devices equipped with them against unauthorized actuation, it is known to use one-time codes, which, when entered into the lock, allow it to be transitioned only one time, from its locked state to its released state. For subsequent transitioning of this electronic lock from its locked state to its released state, entering a new currently valid one-time release code is required.

It is the task of the invention to make available a method for generating a currently valid one-time release code for an electronic lock, by means of which an electronic lock having the greatest possible security against unauthorized actuation can be created.

This task is accomplished, according to the invention, in the case of a method of the type stated initially, in that the currently valid one-time release code is generated by means of encryption of the immediately previously valid one-time release code, by means of an encryption algorithm, whereby the encryption takes place taking an encryption code into consideration.

Use of an encryption algorithm, according to the invention, for generating a currently valid one-time release code represents a very non-typical use of an encryption algorithm, particularly since it is not a matter of making information accessible to anyone accessible only to certain persons. Furthermore, an unauthorized person cannot know what type of encryption algorithm is being used, so that even if an initial currently valid one-time release code is known, no conclusion can be drawn as to what the subsequently generated currently valid one-time release code is going to be. Therefore an electronic lock operated according to the method according to the invention is characterized by a high level of security.

According to an advantageous embodiment of the invention, the encryption code is generated from an individual master code that is entered and a key code that is stored in the electronics of the lock. This makes it possible for the user of an electronic lock to have the future one-time release codes generated individually by means of repeated entry of individual master codes. For third parties, it becomes impossible to obtain knowledge of the currently valid one-time release code, so that no unauthorized actuation of an electronic lock operated according to this embodiment of the method according to the invention can take place. Furthermore, even the manufacturer of an electronic lock operated according to this embodiment of the method according to the invention, who knows the key code stored in the electronics of the lock, cannot make any statement about a currently valid or future one-time release code, as a result of the individualization of the future one-time release code that takes place by means of entering the individual master codes. This embodiment of the method according to the invention therefore serves to create an electronic lock having maximal security to prevent unauthorized actuation.

According to another advantageous embodiment of the invention, the first currently valid one-time release code after startup of the electronic lock is determined taking an entered individual start code into consideration as an immediately previously valid one-time release code. In this way, too, the most extensive individualization possible of the future one-time release codes is achieved. This embodiment furthermore offers the possibility of being able to reset the electronic lock to a defined starting state, if the currently valid one-time release code is no longer known. In such a case, the user of the lock enters an individual start code again, and subsequently enters an individual master code into the electronic lock. In this way, the next currently valid one-time release code is generated. Preferably, the electronic lock can receive a signal as to whether the entered code is supposed to be a start code or a master code.

According to another advantageous embodiment of the invention, AES (Advanced Encryption Standard), DES (Data Encryption Standard), Triple DES, Blowfish, RC4 (Ron's Code 4), RC5 or RC6 is used as an encryption algorithm. These encryption algorithms are characterized by a high level of security.

The above task is furthermore accomplished, in the case of the electronic lock mentioned initially, in that it is set up for implementing the method according to one of the embodiments described above or any desired combination of same. The advantages mentioned above are connected with this.

The above task is furthermore accomplished, according to the invention, in the case of a system of the type stated initially, in that the electronic lock and the electronic device are set up for implementing the method according to one of the embodiments described above or any desired combination of same. Preferably, the currently valid one-time release code is generated not only by the electronics of the lock but also by a program that runs on the electronic device, and is displayed by this electronic device, whereby the same encryption of the immediately previously valid one-time release code takes place, by means of the program, as in the electronics of the lock. By means of the display of the currently valid one-time release code, it is possible for the user of the system according to the invention to obtain knowledge of the currently valid one-time release code, in order to be able to subsequently enter this into the electronic lock. Not only a mobile but also a stationary electronic device is possible as an electronic device. Examples of mobile devices are conventional mobile terminals, laptops, or the like. A PC can be used as a stationary device, for example.

The invention will be explained in greater detail below, using the exemplary embodiments shown in the attached figures. These show:

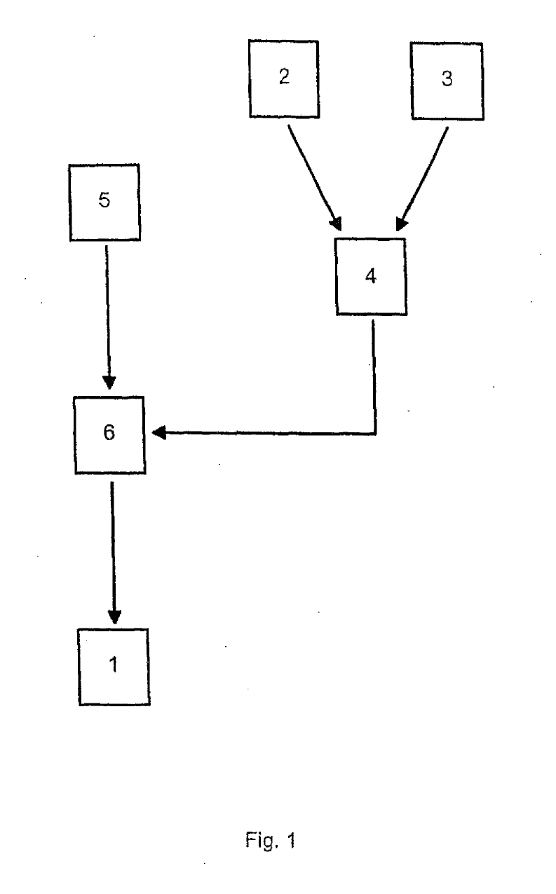

FIG. 1: a schematic representation of the method according to the invention, and

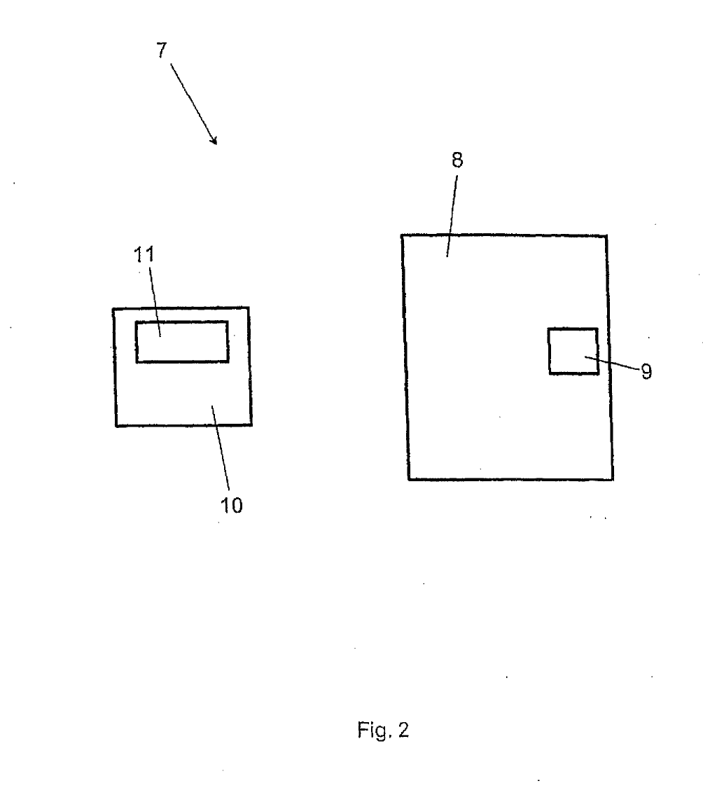

FIG. 2 a schematic representation of an exemplary embodiment of the system according to the invention.

FIG. 1 schematically shows the method according to the invention for generating a currently valid one-time release code 1. First, an individual master code 2 entered into the lock, and a key code 3 stored in the electronics of the lock are used to generate this currently valid one-time release code 1, in order to generate an encryption code 4. This encryption code 4 is taken into consideration in the encryption of the immediately previously valid one-time release code 5 by means of the encryption algorithm 6.

FIG. 2 schematically shows an exemplary embodiment of the system 7 according to the invention, having an electronic lock 9 disposed on a closing element 8 of a closing unit, not shown in any detail, and an electronic device 10 disposed separately from the lock 9, in the form of a PC. To put the electronic lock 9 into operation, first an individual start code is entered into the electronic lock 9 by the user of the electronic lock 9, as an immediately previously valid one-time release code. Subsequently, the user enters an individual master code into the lock. As shown in FIG. 1, the currently valid one-time release code, with which the electronic lock 9 can be transitioned from its locked state into its released state, is generated from these entered codes. The user of the electronic lock 9 is provided, by the manufacturer of the lock 9, with software that is installed on the electronic device 10. This software comprises the same encryption algorithm as that stored in the electronics of the lock 9. Furthermore, the software comprises the same key code as that also stored in the electronics of the lock 9. If the user enters the same individual start code into the electronic device 10, after startup of the lock 9, as the one he already entered into the electronic lock 9, the software that runs in the electronic device 10 generates the currently valid one-time release code as that generated by the electronic lock 9. By way of the display 11 of the electronic device 10, the user can read the currently valid one-time release code and enter it into the electronic lock 9 to transition the electronic lock from its locked state to its released state.

The exemplary embodiments described using the figures serve for an explanation and are not restrictive.

1. Method for generating a currently valid one-time release code (1) for an electronic lock (9), which can be transitioned from its locked state to its released state by means of entering this currently valid one-time release code (1),
wherein
the currently valid one-time release code (1) is generated by means of encryption of the immediately previously valid one-time release code (5), by means of an encryption algorithm (6), wherein the encryption takes place taking an encryption code (4) into consideration.

2. Method according to claim 1, wherein the encryption code (4) is generated from an individual master code (2) that is entered and a key code (3) that is stored in the electronics of the lock (9).

3. Method according to claim 1 wherein the first currently valid one-time release code (1) after startup of the electronic lock (9) is determined taking an entered individual start code into consideration as an immediately previously valid one-time release code (5).

4. Method according to claim 1, wherein AES, DES, Triple DES, Blowfish, RC4, RC5 or RC6 is used as an encryption algorithm (6).

5. Electronic lock (9) that can be transitioned from its locked state to its released state by means of entering a currently valid one-time release code (1),
wherein
it is set up for implementing the method according to claim 1.

6. System (7) having an electronic lock (9) and an electronic device (10) disposed separate from the lock (9),
wherein
the electronic lock (9) and the electronic device (10) are set up for implementing the method according to claim 1.

7. System (7) according to claim 6, wherein the currently valid one-time release code (1) is generated not only by the electronics of the lock (9) but also by a program that runs on the electronic device (10), and is displayed by this electronic device (10), wherein the same encryption of the immediately previously valid one-time release code (5) takes place, by means of the program, as in the electronics of the lock (9).
